(19) United States
(12) Patent Application Publication
(10) Pub. No.: US 2025/0217758 A1
(43) Pub. Date: Jul. 3, 2025

(54) SYSTEMS AND METHODS FOR HYBRID HEURISTIC OPTIMIZATION OF LARGE SCALE DISTRIBUTION NETWORKS

(71) Applicant: Walmart Apollo, LLC, Bentonville, AR (US)

(72) Inventors: Shiv Krishna Jaiswal, Bangalore (IN); Karthik Sundaresan Gurumoorthy, Bengaluru (IN); Ankit Ajit Jain, Bangalore (IN); Shantala Narasimha Murthy Manchenahally, Bangalore (IN)

(21) Appl. No.: 18/400,406

(22) Filed: Dec. 29, 2023

(51) Int. Cl. G06Q 10/087; G06Q 10/0631; G06Q 10/067

(52) U.S. Cl. CPC G06Q 10/087; G06Q 10/06315; G06Q 10/067

(57) ABSTRACT

Systems and methods of hybrid optimization of distribution networks are disclosed. A demand distribution optimization request for a target network is received. A heuristic demand for one or more demand nodes in the target network and a distribution channel capacity for a distribution channel connecting each of the one or more demand nodes and at least one distribution node is generated. An optimized fulfillment data structure representative of an optimized demand fulfillment is generated for the one or more demand nodes. The optimized fulfillment data structure is generated by applying a mixed integer linear programming framework. The optimized fulfillment data structure is stored in a data storage mechanism.

### TECHNICAL FIELD

This application relates generally to optimization of large scale networks, and more particularly, to hybrid optimization frameworks.

### BACKGROUND

Existing heuristic systems for network optimization are configured to receive requirements of nodes within a distribution network and generate a distribution plan for satisfying the received requirements. Existing heuristic systems are not capable of factoring in critical constraints on distribution or node parameters, often generating impractical distribution plans as a result. Similarly, existing heuristic systems are not capable of factoring in distribution channel constraints when preparing a distribution plan.

Some existing heuristic systems utilize one or more rule-based sequential systems to correct impractical distribution plans. However, each rule-based sequential system introduces a corresponding quantum of sub-optimality and maintainability challenges. In addition, existing heuristic systems generate distribution plans periodically, making such systems insensitive to critical and/or real-time changes in the network.

### SUMMARY

In various embodiments, a system including a non-transitory memory and a processor communicatively coupled to the non-transitory memory is disclosed. The processor is configured to read a set of instructions to receive a demand distribution optimization request for a target network, generate a heuristic demand for one or more demand nodes in the target network, generate a distribution channel capacity for a distribution channel connecting each of the one or more demand nodes and at least one distribution node, and generate an optimized fulfillment data structure representative of an optimized demand fulfillment for the one or more demand nodes. The optimized fulfillment data structure is generated by a trained optimization model configured to apply a mixed integer linear programming framework. The optimized fulfillment data structure is stored in a data storage mechanism.

In various embodiments, a computer-implemented method is disclosed. The computer-implemented method includes steps of receiving a demand distribution optimization request for a target network, generating a heuristic demand for one or more demand nodes in the target network, generating a distribution channel capacity for a distribution channel connecting each of the one or more demand nodes and at least one distribution node, and generating an optimized fulfillment data structure representative of an optimized demand fulfillment for the one or more demand nodes. The optimized fulfillment data structure is generated by a trained optimization model configured to apply a mixed integer linear programming framework. The computer-implemented method further includes the step of storing the optimized fulfillment data structure in a data storage mechanism.

In various embodiments, a non-transitory computer-readable medium having instructions stored thereon is disclosed. The instructions, when executed by at least one processor, cause at least one device to perform operations including receiving a demand distribution optimization request for a target network, generating a heuristic demand for one or more demand nodes in the target network, generating a distribution channel capacity for a distribution channel connecting each of the one or more demand nodes and at least one distribution node, and generating an optimized fulfillment data structure representative of an optimized demand fulfillment for the one or more demand nodes. The optimized fulfillment data structure is generated by a trained optimization model configured to apply a mixed integer linear programming framework that includes an item to demand node allocation cost, a distribution channel unit prioritization cost, and a less than minimum capacity cost. The instructions, when executed by the at least one processor, further cause at least one device to perform operations including storing the optimized fulfillment data structure in a data storage mechanism.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide hybrid optimization of a distribution network, in accordance with some embodiments;

FIG. 2 illustrates a computer system configured to implement one or more processes, in accordance with some embodiments;

FIG. 3 is a flowchart illustrating a hybrid optimization method, in accordance with some embodiments;

FIG. 4 is a process flow illustrating various steps of the hybrid optimization method, in accordance with some embodiments;

FIG. 5 is a graph representation of a target network, in accordance with some embodiments;

FIG. 6 illustrates an artificial neural network, in accordance with some embodiments;

FIG. 7 illustrates a tree-based artificial neural network, in accordance with some embodiments;

FIG. 8 illustrates a deep neural network (DNN), in accordance with some embodiments;

FIG. 9 is a flowchart illustrating a training method for generating a trained machine learning model, in accordance with some embodiments; and

FIG. 10 is a process flow illustrating various steps of the training method of FIG. 9, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for hybrid optimization of large scale distribution networks. In various embodiments, a hybrid optimization method is configured to generate an optimized fulfillment data structure embodying an optimized fulfillment plan for a distribution network. The hybrid optimization method includes distribution center and distribution channel resource assignments configured to optimize available resources while fulfilling demand allocation to one or more demand nodes in the network. In some embodiments, the hybrid optimization method provides a dynamically executable optimization method configured to reduce volatility and allocate optimal quantities of resources within the distribution network.

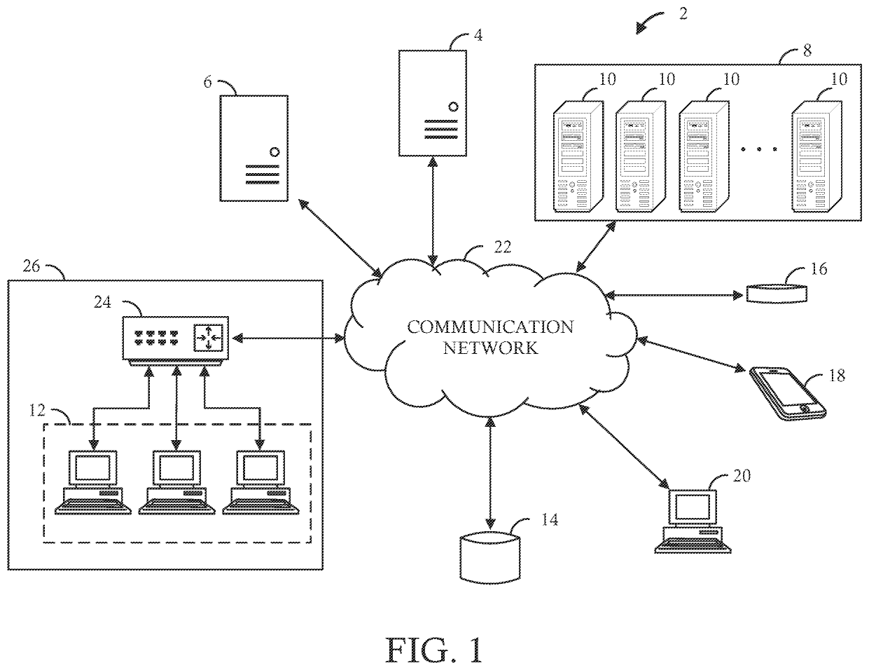

FIG. 1 illustrates a network environment 2 configured to provide hybrid optimization of distribution networks, in accordance with some embodiments. The network environment 2 includes a plurality of devices or systems configured to communicate over one or more network channels, illustrated as a network cloud 22. For example, in various embodiments, the network environment 2 may include, but is not limited to, an optimization computing device 4, a web server 6, a cloud-based engine 8 including one or more processing devices 10, workstation(s) 12, a database 14, and/or one or more user computing devices 16, 18, 20 operatively coupled over the network 22. The optimization computing device 4, the web server 6, the processing device(s) 10, the workstation(s) 12, and the user computing devices 16, 18, 20 may each be any suitable computing device that includes any hardware or hardware and software combination for processing and handling information. For example, each may include one or more processors, one or more field-programmable gate arrays (FPGAs), one or more application-specific integrated circuits (ASICs), one or more state machines, digital circuitry, or any other suitable circuitry. In addition, each may transmit and receive data over the communication network 22.

In some embodiments, each of the optimization computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the optimization computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an intranet network environment and/or a simulation network environment. In some embodiments, the optimization computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the optimization computing device 4, for example. The workstation(s) 12 may communicate with the optimization computing device 4 over the communication network 22. The workstation(s) 12 may send data to, and receive data from, the optimization computing device 4. For example, the workstation(s) 12 may transmit data related to a current status of a distribution network at the physical location 26 and/or tracked operations related to the distribution network performed at the physical location 26 to optimization computing device 4.

Although FIG. 1 illustrates three user computing devices 16, 18, 20, the network environment 2 may include any number of user computing devices 16, 18, 20. Similarly, the network environment 2 may include any number of the optimization computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the optimization computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the first user computing device 16, the second user computing device 18, and the Nth user computing device 20 may communicate with the web server 6 over the communication network 22. For example, each of the user computing devices 16, 18, 20 may be operable to view, access, and interact with a website, such as an optimization and/or simulation website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as initiating generation of an optimization fulfillment data structure, editing an optimization fulfillment data structure, executing an optimized fulfillment data structure, simulating implementation of an optimization fulfillment data structure, and/or viewing data related to any of the available operations. The website may capture these activities as user session data, and transmit the user session data to the optimization computing device 4 over the communication network 22. The website may also allow the user to interact with one or more of interface elements to perform specific operations, such as selecting a distribution network and/or a portion of a distribution network for optimization. In some embodiments, the web server 6 transmits user interaction data identifying interactions between the user and the website to the optimization computing device 4.

In some embodiments, the optimization computing device 4 may execute one or more models, processes, or algorithms, such as a machine learning model, deep learning model, statistical model, algorithmic model, etc., to generate an optimized fulfillment data structure. The optimization computing device 4 may transmit the optimized fulfillment data structure to the web server 6 over the communication network 22, and the web server 6 may display interface elements associated with distribution network and/or the optimized fulfillment data structure on the website to the user. For example, the web server 6 may display interface elements associated with generation, implementation, and/or simulation of an optimized fulfillment data structure on a network interface page.

In some embodiments, the web server 6 transmits an optimization request to the optimization computing device 4. The optimization request may include identification of a large scale network and/or one or more network parameters. In some embodiments, the optimization request includes a dynamic request to optimize an identified portion of a distribution network. In some embodiments, the web server 6 transmits a simulation request to the optimization computing device 4 and/or a separate simulation computing device. The optimization computing device 4 may include a simulation process configured to simulate application of the optimized distribution fulfillment data structure to the distribution network.

The optimization computing device 4 may be further operable to communicate with the database 14 over the communication network 22. For example, the optimization computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the optimization computing device 4, in some embodiments, the database 14 may be a local storage device, such as a hard drive, a non-volatile memory, or a USB stick. The optimization computing device 4 may store interaction data received from the web server 6 in the database 14. The optimization computing device 4 may also receive from the web server 6 user session data identifying events associated with browsing sessions, and may store the user session data in the database 14.

In some embodiments, the optimization computing device 4 generates training data for a plurality of models (e.g., machine learning models, deep learning models, statistical models, algorithms, etc.) based on aggregation data, variant-level data, holiday and event data, recall data, historical user session data, search data, purchase data, catalog data, advertisement data for the users, etc. The optimization computing device 4 and/or one or more of the processing devices 10 may train one or more models based on corresponding training data. The optimization computing device 4 may store the models in a database, such as in the database 14 (e.g., a cloud storage database).

The models, when executed by the optimization computing device 4, allow the optimization computing device 4 to optimize distribution node and/or distribution channel resources for a distribution network to service allocated demand of one or more demand nodes. For example, the optimization computing device 4 may obtain one or more models from the database 14. The optimization computing device 4 may then receive, in real-time from the web server 6, an optimization request including identification of a distribution network (or a portion of a distribution network) and one or more optimization parameters. In response to receiving the optimization request, the optimization computing device 4 may execute one or more models to allocate distribution resources (e.g. distribution node resources, distribution channel resources) to optimize fulfillment of allocated demand to one or more demand nodes.

In some embodiments, the optimization computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, the optimization computing device 4 may generate an optimized fulfillment data structure.

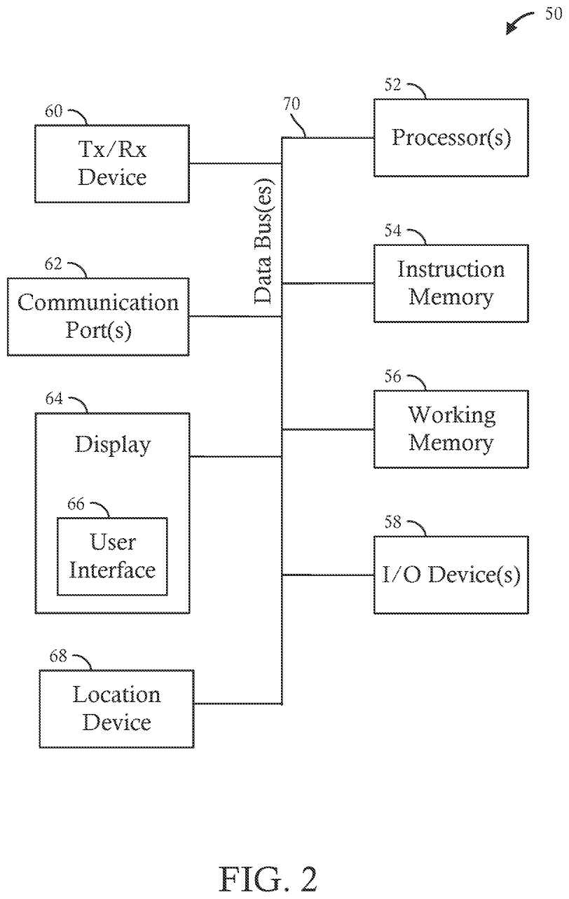

FIG. 2 illustrates a block diagram of a computing device 50, in accordance with some embodiments. In some embodiments, each of the optimization computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for dynamic, hybrid optimization of distribution networks, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with an optimized fulfillment data structure. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to the a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

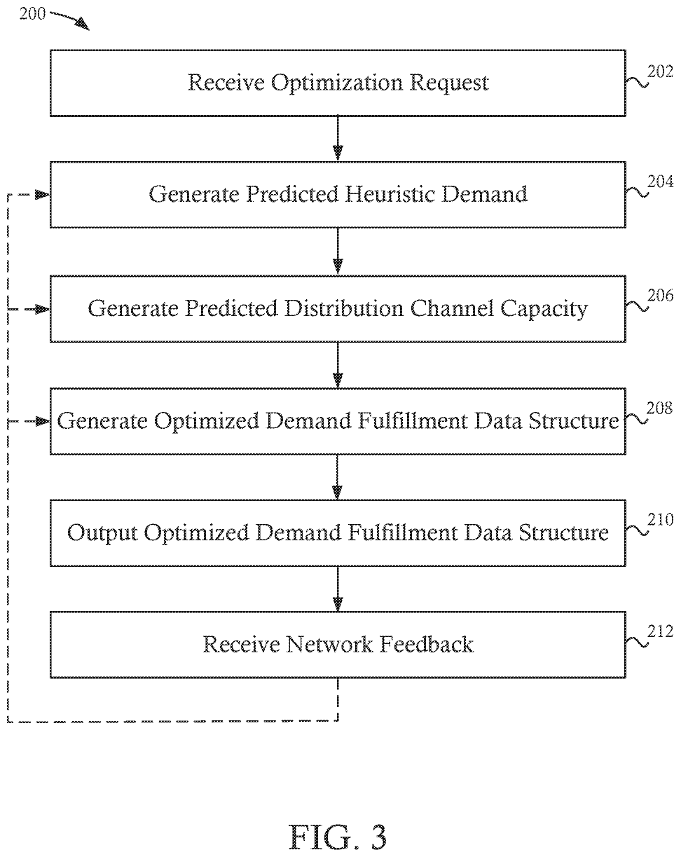

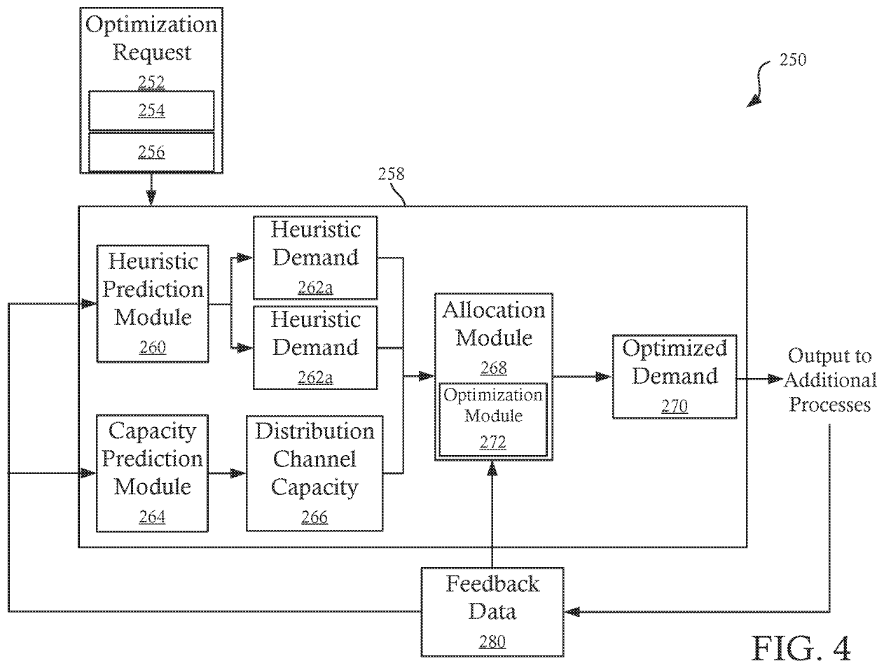

FIG. 3 is a flowchart illustrating a hybrid optimization method 200, in accordance with some embodiments. FIG. 4 is a process flow 250 illustrating various steps of the hybrid optimization method 200 of FIG. 3, in accordance with some embodiments. The hybrid optimization method 200 may be applied periodically and/or dynamically to generate optimized distributions, e.g., optimized distribution fulfillment data structures, of distribution resources of a target distribution network. The hybrid optimization method 200 provides an improved optimization process that incorporates demand allocation for future demand (e.g. pull-forward demand) and one or more constraints including technical constraints (e.g., optimization constraints, distribution capacity constraints, etc.) and/or operational constraints.

At step 202, an optimization request 252 is received. The optimization request 252 may be generated by any suitable system. For example, in some embodiments, the optimization request 252 may be generated by a web server 6, a workstation 12, and/or a user computing device 16, 18, 20 in response to one or more interactions with an optimization and/or simulation interface. The optimization request 252 may be received by any suitable system, device, engine, module, etc., such as, for example, an optimization engine 258. The optimization request 252 may include a request to generate an optimized distribution fulfillment data structure representing an optimized distribution fulfillment plan for a target distribution network.

The network optimization request 252 may include network data 254 defining and/or identifying a target distribution network. For example, in some embodiments, the network data 254 includes an in-memory representation of a target network. As another example, in some embodiments, the network data 254 includes an identifier utilized by the optimization engine 258 to retrieve an in-memory representation of a target network from a data source, such as database 14. As yet another example, in some embodiments, the network data 254 includes one or more parameters and/or identifiers to configure the optimization engine 258 to generate an in-memory representation of a target network. Although specific embodiments are discussed herein, it will be appreciated that any suitable process and/or method may be used to obtain an in-memory representation of a target network as part of a hybrid optimization method 200.

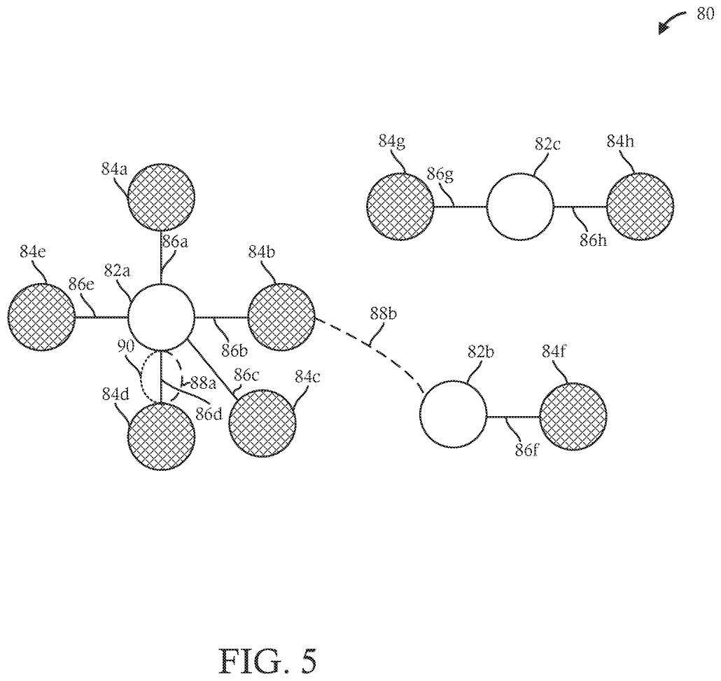

FIG. 5 illustrates a graph representation of an example target network 80, in accordance with some embodiments. The graph representation of the target network 80 includes a multipartite graph including a plurality of distribution nodes 82a-82c (collectively “distribution nodes 82”), a plurality of demand nodes 84a-84f (collectively “demand nodes 84”), a plurality of first distribution channels 86a-86h (collectively “first distribution channels 86”), a plurality of second distribution channels 88a-88b (collectively “second distribution channels 88”), and at least one third distribution channel 90 (collectively, with the first distribution channels 86 and the second distribution channels 88, “distribution channels 86, 88, 90”). Each of the distribution nodes 82 represent a distribution location or element within the target network 80 that provides resources configured to service demand within the target network 80 and each of the demand nodes 84 represent a demand location or element within the target network 80 that consume resources.

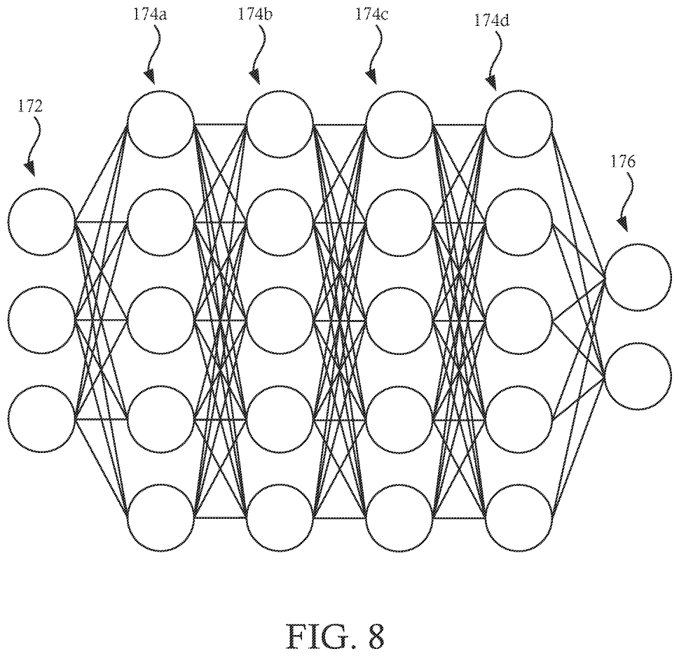

In some embodiments, each of the demand nodes 84 is connected to at least one of the distribution nodes 82 by at least one of the distribution channels 86, 88, 90. As illustrated in FIG. 8, a demand node and a distribution node may be connected by two or more distribution channels, allowing the distribution node to service demand of the demand node utilizing only one of the two or more distribution channels and/or utilizing multiple distribution channels simultaneously. For example, in the illustrated embodiment, the first distribution node 82a may satisfy demand of a second demand node 84b via a first distribution channel 86b and/or a second distribution channel 88a. Similarly, the first distribution node 82a may satisfy demand of a fourth demand node 84d via a first distribution channel 86b, a second distribution channel 88a, and/or a third distribution channel 90.

In some embodiments, a demand node may be connected to (e.g., serviced by) two or more distribution nodes. For example, as shown in the illustrated embodiment, the second demand node 82b may be serviced by the first distribution node 82a and/or by the second distribution node 82b. The demand of the second demand node 82b may be allocated to only one of the connected distribution nodes, e.g., only one of the first distribution node 82a or the second distribution node 82b, and/or may be partially allocated to the first distribution node 82a and partially allocated to the second distribution node 82b.

In some embodiments, the network data 254 may include one or more node features and/or parameters representative of a resource available at a corresponding one of the distribution nodes 82. For example, in some embodiments, each of the distribution nodes 82 include one or more limited resources that may be utilized (e.g., consumed) during fulfillment of demand allocated to the corresponding one of the distribution nodes 82. As one example, in some embodiments including a target supply chain network, each of the distribution nodes 82 may include a loading capacity representative of the volume of demand, e.g., loading volume or weight, that may be satisfied by the corresponding distribution node 82 over a predetermined period, such as a day, an hour, etc. As another example, in some embodiments including a target computing network, each of the distribution nodes 82 may include a compute resource capacity representative of the volume of demand, e.g., compute time or cycles, that may be satisfied by the corresponding distribution node 82 over a predetermined period. Although certain embodiments are discussed herein, it will be appreciated that the target network 80 may include any suitable target network including distribution nodes having associated resources.

In some embodiments, the network data 254 may include one or more node features and/or parameters representative of a cost for consuming a resource at a corresponding one of the distribution nodes 82. For example, to continue the supply chain example from above, a first distribution node 82a in a target supply-chain network may incur a first cost for utilizing loading capacity available at the first distribution node 82a and a second distribution node 82b may incur a second cost for utilizing loading capacity available at the second distribution node 82b. As another example, and with respect to the computing network example above, a first distribution node 82a in a target computing network may incur a first cost for utilizing compute capacity available at the first distribution node 82a and a second distribution node 82b may incur a second cost for utilizing compute capacity available at the second distribution node 82b. The cost for utilizing a resource may include a fixed cost across two or more distribution nodes 82 in a target network and/or may include a variable cost. Similarly, the cost for utilizing a resource at a selected distribution node may include a fixed cost at two or more time periods and/or may include a variable cost. Although specific embodiments and/or examples are discussed herein with respect to certain nodes of the target network 80, it will be appreciated that the disclosed systems and methods may be applied to any suitable nodes of any suitable target network.

In some embodiments, the network data 254 may include one or more channel features and/or parameters representative of a capacity of a corresponding one of the distribution channels 86, 88, 90 to fulfill demand from a corresponding one of the demand nodes 82. For example, in some embodiments, each of the distribution channels 86, 88, 90 may have a fixed and/or variable channel capacity for a predetermined time period. As one example, in some embodiments including a target supply chain network, each of the distribution channels 86, 88, 90 may include a shipping capacity representative of the volume of demand, e.g., shipping volume or weight, that may be satisfied by the corresponding distribution channel 86, 88, 90 over a predetermined period, such as a day, an hour, etc. As another example, in some embodiments including a target computing network, each of the distribution channels 86, 88, 90 may include a data transfer capacity representative of the volume of demand, e.g., data transfer rate or quantity, that may be satisfied by the corresponding distribution channel 86, 88, 90 over a predetermined period. Although certain embodiments are discussed herein, it will be appreciated that the target network 80 may include any suitable target network including distribution channels having associated distribution capacities.

In some embodiments, the network data 254 may include one or more channel features and/or parameters representative of a cost for utilizing a distribution channel 86, 88, 90 to fulfill demand from a corresponding one of the demand nodes 82. For example, to continue the supply chain example from above, a second distribution node 82b may incur a first cost for utilizing shipping capacity available in a first distribution channel 86b and a second cost for utilizing shipping capacity available in a second distribution channel 88a. As another example, and with respect to the computing network example above, a fourth distribution node 82d in a target computing network may incur a first cost for utilizing data transfer capacity available from a first distribution channel 86d, a second cost for utilizing data transfer capacity available from a second distribution channel 88b, and a third cost for utilizing data transfer capacity available from a third distribution channel 90. The cost for utilizing a distribution channel, e.g., a cost incurred by a model and/or a real-world implementation cost, may include a fixed cost across two or more distribution nodes 82 in a target network and/or may include a variable cost. Similarly, the cost for utilizing a distribution channel to service a specific demand node from a selected distribution node may include a fixed cost at two or more time periods and/or may include a variable cost.

In some embodiments, the target network 80 is representative of a large-scale supply chain distribution network. In such embodiments, the distribution nodes 82 may be representative of distribution locations (e.g., warehouses) configured to service supply demand of demand nodes 84 representative of supply chain demand consumers (e.g., retail stores, local consumers, etc.), the first distribution channels 86 may be representative of a first supply chain distribution channel (e.g., freight shipping via trailers at regular schedules), the second distribution channels 88 may be representative of a second supply chain distribution channel (e.g., on-demand shipping via trailers), and the third distribution channel 90 may be representative of a third supply chain distribution channel (e.g., on-demand shipping via third-party commercial carriers). As another example, in some embodiments, the target network 80 is representative of a large-scale distributed computing environment in which the distribution nodes 82 may be representative of available cloud compute nodes (e.g., cloud computing servers, processors, memory, storage, etc.), the demand nodes 84 may be representative of consumers of the cloud computing resources (e.g., local computing systems, cloud applications, data services, etc.), the first distribution channels 86 may be representative of a first access channel (e.g., wired network access), the second distribution channel 88 may be representative of a second access channel (e.g., wireless or cellular network access), and the third distribution channel(s) 90 may be representative of a third access channel (e.g., local access). It will be appreciated that these embodiments are exemplary and additional networks may be modeled and/or optimized by the optimization computing device 4.

In some embodiments, a target supply chain network may include brick-and-mortar supply chain locations and/or processes (e.g., in-store stocking, sales, tracking, warehousing, distribution locations, receiving locations, etc.) and/or online supply chain processes (e.g., distributed stock tracking, internet-based sales or interactions, delivery processes, third-party merchant processes, online distribution locations, customer delivery locations, etc.). The optimization computing device 4 may be configured to receive a plurality of inputs, for example, from processing device(s) 10, workstation(s) 12, database 14, one or more user computing devices 16, 18, 20, etc. representative of a historical and/or current state of the supply chain network (e.g., state of each node and/or channel). The optimization computing device 4 is configured to receive any suitable type of input, such as, for example, a heuristic input, a statistical input, a deep learning generated input, etc. suitable for incorporation into a distribution network optimization process, as discussed herein.

In some embodiments, the network optimization request 252 may include parameter data 256 defining operational parameters, constraints, costs, etc. for optimization of the target network 80. For example, in some embodiments, the parameter data 256 includes one or more parameters defining a scope of an operation of a target network 80. For example, in some embodiments, the parameter data 256 can include a time frame parameter (e.g., past-simulation, present or near-term simulation, future simulation, etc.), a granularity parameter (e.g., coarse granularity, medium granularity, fine granularity, etc.), a fidelity parameter (e.g., low fidelity, medium fidelity, high fidelity, etc.), demand generation parameters (e.g., parameters related to the demand to be simulated), network inputs (e.g., parameters defining certain structural elements of the simulated process or network), constraint parameters (e.g., parameters constraining the simulation or the system during simulation), etc. The parameter data 256 may additionally and/or alternatively include parameters defining a target output of the target network 80, such as, for example, a target demand, a target cost, a target value, etc. Although specific embodiments are discussed herein, it will be appreciated that any suitable input parameters, such as required or optional parameters, for the simulation can be included in the parameter data 256.

In some embodiments, the parameter data 256 may include and/or can be used to generate a set of inputs to be used by an optimization engine 258. For example, in some embodiments, parameter data 256 may include, but is not limited to, input data such as historical data representative of actual performance or operation of the target network during a prior time period, real-time data representative of current conditions or operation of the target network, and/or predicted inputs generated for one or more time periods, such as past, present, and/or future predicted inputs. In some embodiments, one or more inputs (or parameters) may be generated by one or more input generation models.

In some embodiments, the parameter data 256 defines a set of constraints, operational objectives, requirements, and/or elements for optimization of a target network 80. For example, in some embodiments, the parameter data 256 include network parameters such as overall network demand, maximum network demand, minimum network demand, fixed and/or variable cost(s) incurred by a distribution node utilizing a resource and/or distribution channel, distribution node and/or distribution channel capacity, operational targets or requirements (e.g., minimum percentage of demand to be fulfilled, maximum cost to be incurred, etc.) and/or any other suitable network constraints or parameters. As a non-limiting example, in some embodiments, a distribution node loading capacity may include a hard capacity limit or a soft capacity limit.

In some embodiments, network data 254 and/or parameter data 256 may be generated by an ingestion process configured to perform real-time, near real-time (e.g., micro batching), and/or batch ingestion of production data related to a target network. In some embodiments, an ingestion process is configured to receive production data, process received production data, and store processed data in one or more storage systems, such as a database. The ingestion process may implement any suitable ingestion modules, processes, algorithms, etc., such as, for example, extraction processes, processing modules, type identification processes, flow tracking and visualization processes, volume processes, security processes, sanitization processes, normalization processes, etc. Although specific embodiments are discussed herein, it will be appreciated that any suitable set of ingestion processes can be utilized to process received production data. The ingested data may be generated by any suitable systems, such as, for example, one or more production systems configured to implement and/or monitor at least a portion of an actual implementation of a target network.

In some embodiments, the parameter data 256 includes and/or is utilized to generate one or more inputs. For example, the optimization computing device 4 may be configured to implement one or more trained models and/or statistical processes to generate heuristic-based inputs, statistical-based inputs, deep learning-based inputs, machine learning-based inputs, and/or other types of inputs. The optimization computing device 4 may implement multiple, different input generation processes simultaneously, sequentially, and/or intermittently to generate required inputs for a simulation. As one example, in some embodiments, a demand parameter may be generated for a target network.

At step 204, a predicted heuristic demand 262a, 262b (collectively “heuristic demand 262”) for a demand node, e.g. a first demand node 84a, is generated for one or more time periods. For example, in some embodiments, heuristic demand 262 may be predicted for multiple days, weeks, etc. of a future time period. As one non-limiting example, in some embodiments, heuristic demand 262 may be determined for each day (e.g., 24-hour period) of a future week (e.g., subsequent week from current date). The heuristic demand 262 may be generated by any suitable system, device, engine, module, etc., such as, for example, a heuristic prediction module 260.

In some embodiments, the heuristic prediction module 260 includes one or more trained heuristic prediction machine learning models and/or one or more rules engines configured to generate heuristic demand 262. Heuristic demand 262 may be generated for one or more demand units that may be consumed at the selected demand node 84a. For example, in embodiments including a target supply-chain network, the heuristic prediction module 260 may be configured to generate a heuristic demand forecast including replenishment requests for each of a plurality of inventory items stocked by and/or maintained by a selected demand node. Replenishment requests may include expected shipment requests for units of inventory items from a distribution node, e.g., a distribution center or warehouse, to the corresponding demand node, e.g., a retail store.

In some embodiments, a heuristic demand generated for a selected demand node may include a first granularity. For example, to continue the supply-chain example from above, in some embodiments, replenishment requests may be available and/or processed via a first granularity unit related to a plurality of individual units of an inventory item (e.g., packs, boxes, crates, cases, etc.). In some embodiments, consumption of a corresponding resource, e.g., corresponding inventory, at a demand node may be a rate defined in a second granularity unit, such as, for example, a rate related to individual units of an inventory item. Although specific embodiments are discussed herein, it will be appreciated that any suitable first granularity and/or second granularity may be used to define network demand units and the first granularity may or may not be related to the second granularity.

In some embodiments, the heuristic prediction module 260 is configured to incorporate a buffer into the heuristic demand 262. For example, in some embodiments, the heuristic prediction module 260 may determine a heuristic demand 262a, 262b two or more upcoming time periods (e.g. two or more upcoming days, weeks, etc.) based on historical demand data for the demand node 84a and add an additional buffer demand value to the historically determined heuristic demand. A buffer demand value may be a fixed value and/or a variable value configured to account for uncertainties in demand values that would result in unmet demand at the demand node 84a. For example, in embodiments including a target supply-chain network, a demand buffer to prevent an out-of-stock state at the demand node 84a may be added to heuristic demand 262. Although specific embodiments are discussed herein, it will be appreciated that any suitable demand buffer may be added based on any suitable network parameters.

At step 206, a distribution channel capacity 266 for at least one distribution channel connecting a distribution node with the selected demand node is predicted and/or determined, such as, for example, a distribution channel capacity 266 for a first distribution channel 86a providing demand fulfillment from a first distribution node 82a to a first demand node 84a. In some embodiments, a distribution channel capacity 266 is determined by a demand capacity prediction module 264 configured to predict and/or model a distribution channel, e.g., distribution channel 86a. The distribution channel capacity 266 may be provided with respect to overall capacity of a distribution channel 86a and/or may be determined with respect to individual distribution elements implemented by and/or on the distribution channel 86a. For example, in some embodiments including a target supply-chain network, the distribution channel capacity 266 may include a trailer capacity representative of an available freight shipping capacity of a scheduled trailer traveling from the distribution node 82a to the demand node 84a as part of the distribution channel 86a. As another example, in some embodiments including a target computing network, the distribution channel capacity 266 may include total data transfer capacity for a predetermined time period. Although specific embodiments are discussed herein, it will be appreciated that any suitable distribution channel capacity 266 may be determined for at least one distribution channel servicing a selected demand node.

At step 208, an optimized fulfillment data structure 270 is generated to optimally fulfill the predicted heuristic demand 262 based on the predicted distribution channel capacity 266. The optimized fulfillment data structure 270 is configured to provide distribution allocation incorporating both immediate demand needs for each demand node and future demand needs for each demand node beyond a current time period, referred to herein as pull-forward demand. The optimized fulfillment data structure 270 may be generated by any suitable system, device, engine, module, etc., such as, for example, an allocation module 268.

In some embodiments, the allocation module 268 is configured to generate an optimized fulfillment data structure 270 representative of a completed demand (or allocation) plan. The generated optimized fulfillment data structure 270 is configured to maximize distribution channel capacity (or throughput) to provide optimized fulfillment of both short term upcoming demand and pull-forward demand, resulting in optimized usage of distribution node resources and distribution channel resources. For example, in embodiments including a supply-chain network, the optimized fulfillment data structure 270 may be configured to optimize usage of a loading resource (e.g., loading capacity or labor available at a warehouse) and a shipping resource (e.g., shipping capacity available in individual freight containers). The optimized fulfillment data structure 270 incorporates additional constraints (e.g., labor capacity/scheduling constraints for distribution nodes, storage constraints for demand nodes, etc.), providing a unified allocation solution resulting in cost improvements and increased efficiencies within the target network 80.

In some embodiments, the allocation module 268 is configured to generate the optimized fulfillment data structure 270 by applying (e.g., executing, instantiating, etc.) an optimization module 272 configured to receive the predicted heuristic demand 262 and the predicted distribution channel capacity 266 for a selected distribution node-demand node pair, e.g., distribution node 82a and demand node 84, and output the optimized fulfillment data structure 270 (or data used to generate the optimized fulfillment data structure 270). The optimization module 272 may include any suitable framework, such as, for example, a rules-based framework, an algorithmic framework, a neural network framework, a deep neural network framework, a neural diving framework, a neural branching framework, etc.

In some embodiments, the optimization module 272 is configured to apply a machine learning framework configured generate mixed integer linear programming (MILP) solutions. For example, in some embodiments, the optimization module 272 may be trained (e.g. configured) to arrange generation of an optimized fulfillment data structure 270 as a linear function, e.g.:

$$Obj ( {d}_{i , {j}^{,}}^{t} {x}_{j} , {b}_{j} ) = ( {\sum }_{i ∈ I , j ∈ J , t ∈ {T}_{i , j}} α [ t ] {q}_{i , j}^{t} {d}_{i , j}^{t} ) + β ( {\sum }_{j ∈ J} {p}_{j} {x}_{j} ) - γ ( {\sum }_{j ∈ J} {b}_{j} )$$

where I is a set of all items (e.g., inventory items, data items, etc.) maintained (e.g., stocked, stored) by a demand node, J is a set of all demand nodes, T_{i,j} is a set of time indices in which there is a need of an i^{th} item at a j^{th} demand node, D_{i,j}^{t} is a demand for the i^{th} item at the j^{th} demand node at time t, d_{i,j}^{t} is an allocation for the i^{th} item at the j^{th} demand node at time t, xⱼ is a number of allocated distribution channel units to the j^{th} demand node (e.g., the number of planned trailers to a j^{th} retail store), q_{i,j}^{t} is a quantification factor (discussed in greater detail below), pⱼ is demand node priority, b_{j t} is a slack variable representative of a minimum capacity breach of a last demand unit for the j^{th} demand node, and α, β, and γ are weighting factors. The weighting factors may be determined during iterative training of the optimization module 272.

In some embodiments, the first term of the objective function is representative of an item to demand node allocation cost, the second term is representative of a distribution channel unit prioritization cost, and the third term is representative of a cost incurred due to distribution units having less than a predetermined minimum capacity. For example, in embodiments including a target supply-chain network, the first term may be representative of an item to store allocation cost, the second term may be representative of a trailer prioritization cost, and the third term may be representative of a cost incurred due to less than minimum capacity trailer allocation. Although specific embodiments are discussed herein, it will be appreciated that any suitable costs for any suitable target network may be modeled and optimized.

In some embodiments, the first term of the object function defines an item to demand node allocation cost including multiple cost components. For example, the demand node allocation cost may include allocation d_{i,j}^{t} of the i^{th} item at the j^{th} demand node at time t (e.g., allocation of an i^{th} item at the j^{th} store on the t^{th} day), a quantification factor representative of an importance of the i^{th} item at the j^{th} demand node at time t (e.g., q_{i,j}^{t}), referred to herein as a “quantification factor,” and a weight vector α[t] to calibrate allocation coverage and pull forward times indexed by t. The quantification factor may be generated based on one or more underlying features or parameters, such as, for example, demand node status (e.g., new demand node, existing demand node, etc.), rate of consumption for the i^{th} item, availability (e.g., inventory) of the i^{th} item at the j^{th} demand node, quantity of the i^{th} item in-route to the j^{th} demand node, e.g., via a distribution unit of an associated distribution channel, item priority rules, etc. α[t] may include a monotonically decreasing function configured to prioritize immediate needs of an item at a demand node. The use of a monotonically decreasing function prevents surplus allocation of an item at one demand node and unavailability of the item at a second demand node.

In some embodiments, a distribution channel unit prioritization cost is configured to model, or incorporate, a cost incurred between distribution via a distribution channel for individual demand nodes. For example, in the context of a target supply-chain network, shipments (e.g., freight trailers) may be assigned to certain demand nodes (e.g., stores) at specific intervals or at specific times, referred to herein as a “review period.” Demand nodes having a longer review period may incur a higher cost if an item is not provided by a distribution unit as compared to a demand node having a shorter review period. The distribution channel unit prioritization cost provides a cost value representative of the cost for a demand unit to receive/not receive an item in a scheduled distribution unit.

In some embodiments, the optimization process includes a cost incurred due to distribution units having less than a predetermined minimum capacity (“LTMC”), e.g., bⱼ, referred to herein as a “LTMC cost.” The LTMC cost may represent situations in which a less-than-minimum capacity distribution unit is required to be sent to a demand node to satisfy one or more constraints of the demand node and/or network. For example, in embodiments including a target supply-chain network, a LTMC shipment may occur in situations where a store requires an item to be provided immediately to avoid an out-of-stock state. The LTMC cost variable, and the associated weighting factor γ, determines an extent to which minimum capacity breach may be allowed (e.g., setting γ=inf is equivalent to disallowing minimum capacity breach and setting γ=0 is equivalent to having no constraint on minimum capacity breach).

In some embodiments, one or more constraints are applied to the optimization process, for example, as inputs to and/or features calculated by the optimization module 272. For example, an inventory constraint may be applied such that for any item i, the sum of the total allocation across all demand nodes serviced by a distribution node is within the available quantity of the corresponding item (e.g., the available item resource) for the distribution node, e.g.:

$${\sum }_{j ∈ J} {s}_{i , j} \leq {S}_{i}$$

where i∈I, s_{i,j} is the total quantity of the i^{th} item sent to the j^{th} demand node and Sᵢ is the total available quantity of the i^{th} item at a corresponding distribution node.

As another example, in some embodiments, a resource constraint may be applied for one or more distribution nodes. For example, in embodiments including a target supply-chain network, a warehouse labor constraint may be applied for a distribution node (e.g., warehouse). Various types of resources or sub-resources (e.g., various types of labor at a warehouse) may be defined. A constraint ensuring that a resource type l is within the available resource Dₗ of the corresponding distribution node may be defined as:

$${\sum }_{i ∈ {I}_{l} , j ∈ J} {s}_{i , j} \leq {D}_{l}$$

where l∈L.

As yet another example, in some embodiments, a planned distribution unit constraint may be applied to for one or more distribution channels. The planned distribution unit constraint may represent the available capacity of a demand node to consume available distribution units within a distribution channel. For example, in embodiments including a target supply-chain network, a demand node (e.g., a store) may have constraints, such as labor constraints, on the number of distribution units (e.g., trailers) that can be unloaded at each demand node. A planned distribution unit constraint may be defined as:

xⱼ≤Rⱼ

where j∈J and Rⱼ is a number of planned distribution units for the j^{th} demand node.

As still another example, in some embodiments, a distribution unit max capacity constraint may be applied to ensure that the total items provided to a demand node is within the available capacity (e.g., inventory space, storage space, etc.) of all distribution units provided to the demand node. For example, in embodiments including a target supply-chain network, a trailer max capacity constraint may be applied to ensure the total items shipped to a demand node (e.g. a store) are within the available inventory storage space for the corresponding demand node. A distribution unit max capacity constraint may be defined as:

sⱼ≤Mx₁

where j∈J and M is an item carrying capacity of each distribution unit.

Additional constraints may include, but are not limited to, a distribution unit minimum capacity constraint, a demand node item constraint, and/or an item flow constraint. In some embodiments, a distribution unit minimum capacity constraint represents a minimum number of items (m) that should be included in a distribution unit. As discussed above, in some embodiments, a minimum capacity breach cost may be incurred for allowed breaches of minimum capacity distributions, such that:

$$0 \leq {b}_{j} \leq m$$

$$M ( {x}_{j} - {y}_{j} ) + {my}_{j} - {b}_{j} \geq {s}_{j}$$

where j∈J, M is an item carrying capacity of each distribution unit, and:

yⱼ=min(1,xⱼ)

which is equal to 0 where no distribution unit is dispatched and 1 otherwise. In some embodiments, a demand node item constraint enforces constraints to prevent over-assignment of certain items, defined as:

s_{i,j}≤nodeCap_{i,j}

d_{i,j}^{t}≤D_{i,j}^{t}

where nodeCap_{i,j} represents the portion of a demand node resource reserved for the i^{th} item at the j^{th} demand node. In some embodiments, an item flow constraint enforces a requirement that the total quantity of an item reaching a demand node is equal to the sum of allocated quantity for the demand node, defined as:

$${s}_{i , j} = {\sum }_{t ∈ {T}_{i , j}} {d}_{i , j}^{t}$$

where i∈I, j∈J. Although specific embodiments are discussed herein, it will be appreciated that any suitable constraints may be applied during optimization at step 208.

In some embodiments, a batch process is applied to generate one or more parameters required by the optimization process at step 208. For example, in some embodiments, an iterative batched submodular process is applied to approximate allocation of distribution units for each demand node. The iterative batched submodular process may be applied beginning with a demand node having a highest priority pⱼ, although it will be appreciated that other starting points may be utilized. The iterative batched submodular process may assign distribution units to demand nodes in higher-priority batches first before assigning distribution units to demand nodes in lower-priority batches. Assignment of distribution units is retained across each assignment, creating a submodular assignment in which already-assigned distribution units are not tested in subsequent iterations.

In some embodiments, an incremental gain is defined to represent the benefit of adding a new distribution unit to a demand node within a batch. The incremental gain may be used to remove demand nodes from a batch in order to identify stores that may not be assigned to distribution unit. The demand node having the highest incremental gain receives assignment of a new distribution unit until the number of assigned distribution units reaches a maximum. The incremental gain may be used to assign a predetermined number and/or a variable number of distribution units to each demand node in a batch. In some embodiments, the optimized fulfillment data structure 270 may be generated by allocating demand units to distribution units assigned to individual demand nodes by applying the MILP framework discussed above.

As one example, assume that a set of three demand nodes each include the same priority and that the current set of mapped distribution units is an empty set. At a first iteration of the iterative batched submodular process, the incremental gain for each of the three demand nodes is determined, for example, a first demand node (“Node1”) having an incremental gain of 100, a second demand node (“Node2”) having an incremental gain of 90, and a third demand node (“Node3”) having an incremental gain of 95. At the first iteration, a first distribution unit is assigned to Node1, which has the highest incremental gain of 100. In a second iteration of the iterative batched submodular process, the incremental gain of Node1 is recalculated after assignment of the first distribution unit, for example resulting in an updated incremental gain of 82. The incremental gain for Node2 and Node3 is not changed, and therefore the incremental gain from iteration 1 can be reused for Node2 and Node3. At the second iteration, the second distribution unit is assigned to Node3, which has the highest incremental gain of 95. The iterative batched submodular process continues until each of the nodes has a maximum number of distribution units assigned and/or a maximum number of distribution units has been assigned. After assignment of trailers to each of the nodes, the optimization module 272 may apply the objective function defined above to assign demand units to each distribution unit associated with a demand node.

In some embodiments, the allocation module 268 may be dynamically executed based on changes in a corresponding target network. For example, in some embodiments, the allocation module 268 may be dynamically invokable when one or more predetermined changes occur within a target network. Predetermined changes may include, but are not limited to, changes to distribution node resources, distribution channel resources, demand node resources, demand node consumption, addition and/or removal of demand nodes and/or distribution nodes, etc. In some embodiments, the allocation module 268 may be dynamically executed in response to an updated predicted heuristic demand 262 and/or an updated distribution channel capacity 266. It will be appreciated that any suitable automatic and/or manual trigger may be defined for dynamically executing the allocation module 268.

At step 210, the optimized fulfillment data structure 270 is output. The optimized fulfillment data structure 270 may be stored in a data storage mechanism, such as database 14, and/or utilized for additional processing. In some embodiments, the optimized fulfillment data structure 270 may be provided to a simulation system for simulation of the optimized fulfillment data structure 270, a demand fulfillment system (e.g., inventory control system) for implementation of the optimized fulfillment data structure 270, incorporated into a user interface for review of the optimized fulfillment data structure 270, and/or otherwise additionally processed.

At step 212, network feedback data 280 may be received and the optimized fulfillment data structure 270 may be updated and/or regenerated. For example, in some embodiments, a monitoring system 282 may be configured to receive network feedback data 280 related to a target network. The received network feedback data 280 may include new parameters defining a simulated target network, operational parameters or status of a monitored target network, and/or any other suitable feedback related to a target network 80. For example, the network feedback data 280 may include, but is not limited to, predicted and/or simulated operation of a target network, feedback data regarding current state of a target network, predicted and/or target metrics for a target network, etc. In some embodiments, receipt of network feedback data 280 causes regeneration of the optimized fulfillment data structure 270, for example, through iterative execution of any of steps 204-210 as discussed herein.

The disclosed hybrid optimization method 200 provides a forward looking (e.g. future, predictive, etc.) allocation system that provides for allocation of resources (e.g., inventory) based on current and future needs of demand nodes. The provided optimization framework enables utilization of existing supply capabilities (e.g., existing shipping/loading capacity, truck capacity, network capacity, etc.) to enable forward looking allocation of network resources to better fulfill demand node needs and more efficiently utilize available network resources. The disclosed hybrid optimization method 200 provides an automatic tradeoff between allocation more resources to demand nodes and simultaneously minimizing storage of excessive resources for longer time periods or over-assignment of resources to reduce demand node costs. The disclosed hybrid optimization method 200 utilizes sub-modularity to solve a corresponding optimization framework, providing fast and accurate forward-looking allocations.

In some embodiments, the hybrid optimization method 200, and the associated systems, engines, modules, models, etc., may be implemented for a large-scale supply chain network. For example, at step 202, an optimization request for optimization of at least one or more distribution nodes (e.g., warehouses, distribution centers, etc.) in the large-scale supply chain network may be received. The optimization request may include a request to optimize deliveries via one or more trailers or other shipping mechanism to one or more demand nodes (e.g., stores, other distribution centers, etc.).

In some embodiments, optimization of a large-scale supply chain network may include one or more constraints. For example, in some embodiments, an optimization request related to a large-scale supply chain network may include constraints defining labor availability at a distribution node (e.g., warehouse), allocated inventory to all stores that are serviced by the warehouse, a maximum number of items that can be accommodated in planned trailers for each store, a minimum number of items that should be loaded into each trailer for it to leave the warehouse, a storage capacity for the store associated with the trailer, a number of dispatched trailers to a store being less than or equal to the number of planned trailers, and an economic shipment quantity for each item. Although specific embodiments are discussed herein, it will be appreciated that any suitable constraints can be applied to optimization of a large-scale supply chain network.

At step 204, a predicted heuristic demand for the demand node (e.g., store) may be generated for an upcoming time period, such as an upcoming delivery period, an upcoming time period encompassing multiple deliveries, etc. For example, in some embodiments, heuristic demand may be predicted for multiple days, weeks, etc. of a future time period. Heuristic demand may be generated for replenishment requests for each of a plurality of inventory items stocked by and/or maintained by a selected store.

At step 206, a trailer capacity for one or more trailers assigned from a warehouse to the store may be determined. For example, in some embodiments a trailer capacity representative of an available freight shipping capacity of a scheduled trailer may be determined. At step 208, an optimized fulfillment data structure is generated to optimally fulfill the predicted heuristic demand of the large-scale supply chain network based on the predicted trailer capacity of the one or more trailers. The optimized fulfillment data structure is configured to provide distribution allocation incorporating both immediate demand needs for the store and future demand needs for the store, e.g., pull-forward demand, that can be accommodated within the trailer capacity. The optimized fulfillment data structure may be configured to optimize usage of loading resources (e.g., loading capacity or labor available at the warehouse), shipping resources (e.g., shipping capacity available in individual freight containers), etc. The optimized fulfillment data structure incorporates the network constraints discussed above, providing a unified allocation solution resulting in cost improvements and increased efficiencies within the large-scale supply chain network.

In some embodiments, a trained optimization model is configured to receive the predicted heuristic demand and the predicted trailer capacity for each warehouse-store pair and generate an optimized fulfillment output. The trained optimization model may be configured to maximize an objective function (as discussed above) where the terms of the object function correspond to item to store allocation costs, trailer prioritization costs, and costs due to less than minimum capacity trailers, respectively. The allocation cost of the large-scale supply chain network includes the allocation of an item to a selected store at a selected time, the importance of the item to the store at a selected time, and a weight vector to calibrate over coverage and pull-forward demand.

In some embodiments, optimized fulfillment structures for a large-scale supply chain network may be generated in batches, with each batch including a set of stores serviced by one or more warehouses (e.g., distribution nodes). In some embodiments, a batch assignment process may include assignment of trailers to a given batch (e.g., scheduling of trailers for delivery to a store). In some embodiments, the disclosed batch process based on incremental gain as discussed above with respect to step 208 may be applied to assign trailers to each batch of stores and warehouses in a large-scale supply chain network.

Embodiments utilizing the disclosed hybrid optimization method 200 for large-scale supply chain networks provide higher labor usage and improved trailer utilization as compared to systems utilizing some known optimization processes. In some embodiments, the hybrid optimization method 200 prioritizes allocating surplus items to those stores which will be turning over inventory at a higher rate, keeping the number of days the item lasts (days of supply or DOS) at the store to a minimum. In addition, the disclosed hybrid optimization method 200 provides for reduced lost sale due to reduction of out-of-stock items. The disclosed framework provides for allocation to each trailer within the limit of its maximum capacity and provides a number of trailers dispatched to store within a defined planned limit.

It will be appreciated that generation of an optimized fulfillment data structure as disclosed herein, particularly for large distribution target networks such as large-scale supply chain or compute networks, is only possible with the aid of computer-assisted algorithms and techniques, such as the disclosed optimization model. In some embodiments, machine learning processes including MILP processes, enforced costs, and/or in-memory representations of target networks are used to perform operations that cannot practically be performed by a human, either mentally or with assistance, such as generation of an optimized fulfillment data structure representative of an optimized fulfillment plan for the target network. It will be appreciated that a variety of machine learning techniques can be used alone or in combination to generate the optimization model and/or the optimized fulfillment data structure.

In some embodiments, systems, and methods for hybrid optimization of distribution networks includes one or more trained hybrid optimization models. The trained hybrid optimization models may include one or more models configured to implement an optimization framework. In some embodiments, a trained hybrid optimization model is configured to implement an iterative, batched submodular process for generating optimal allocation of resources within distribution nodes and/or distribution channels for servicing allocate demand of one or more demand nodes.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network and/or a generative adversarial network.

In various embodiments, neural networks which are trained (e.g., configured or adapted) to generate optimized fulfillment data structures, are disclosed. A neural network trained to generate an optimized fulfillment data structure may be referred to as a trained optimization model. A trained hybrid optimization model may be configured to receive a set of input data, such as, for example, a network definition and/or representation and one or more network parameters, and generate an optimized fulfillment data structure representative of an optimized distribution fulfillment plan for the corresponding network definition.

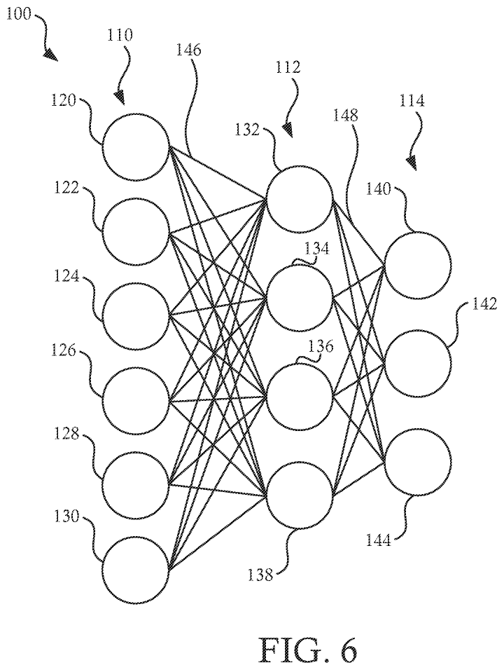

FIG. 6 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ⁽ⁿ⁾denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾ if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

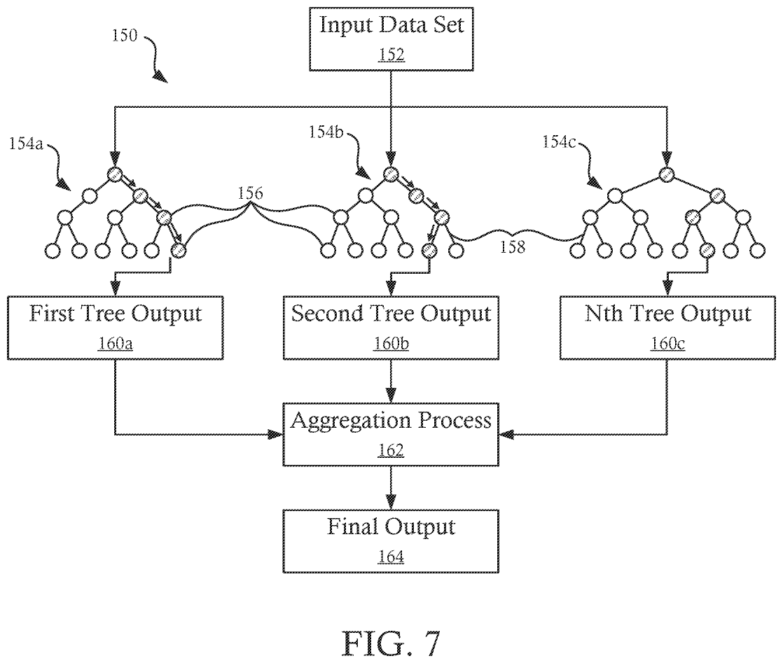

FIG. 7 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

FIG. 8 illustrates a deep neural network (DNN) 170, in accordance with some embodiments. The DNN 170 is an artificial neural network, such as the neural network 100 illustrated in conjunction with FIG. 3, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a pre-activation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

y=e^{β}e^{ƒ(log x)}e^{Σ}^{ᵢ}^{ƒ}^{ᵢ}^{^{d}}^{(d}^{ᵢ}⁾

where d represents one or more features of the independent variable x.

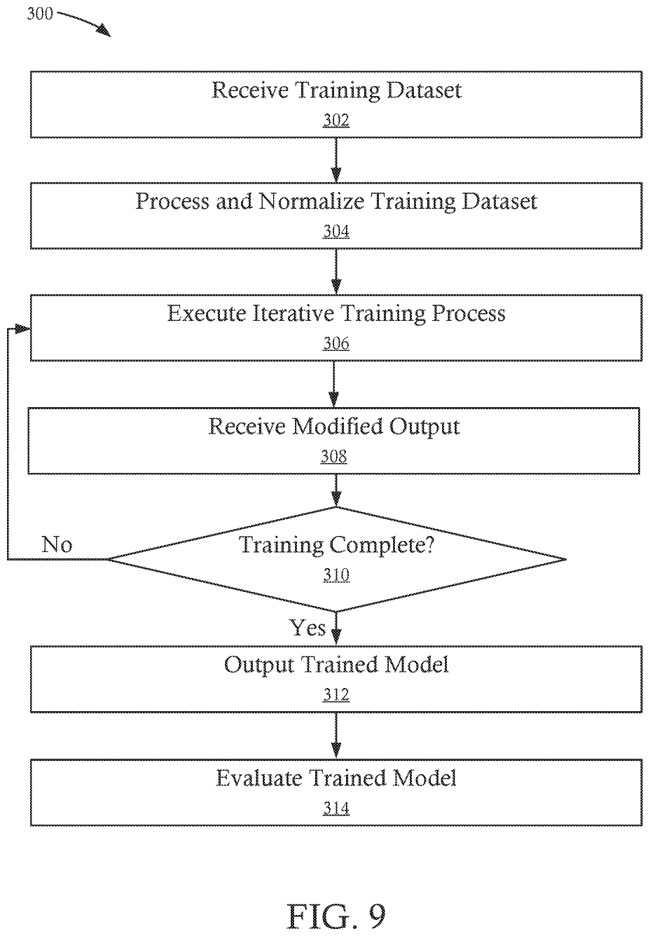

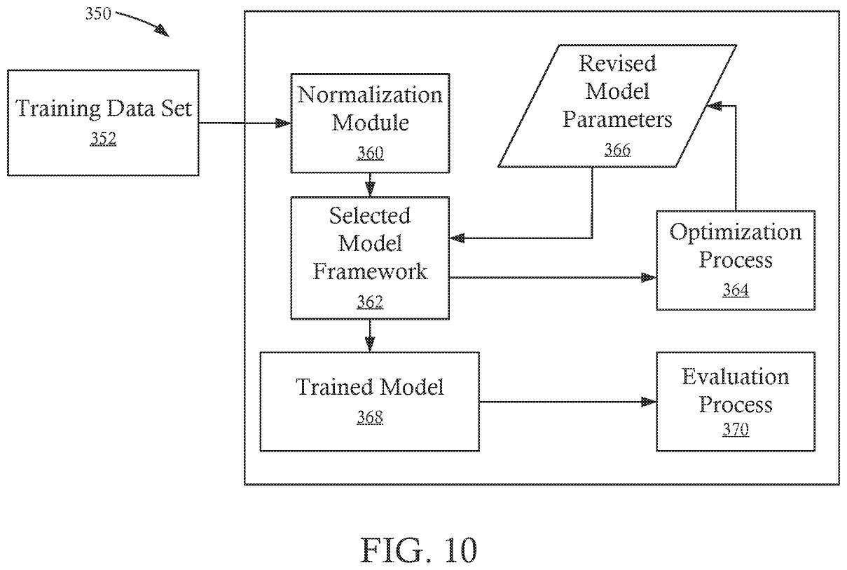

In some embodiments, an optimization engine 258 can include and/or implement one or more trained models, such as a heuristic prediction model, a trained capacity prediction model, and/or a trained optimization model. In some embodiments, one or more trained models can be generated using an iterative training process based on a training dataset. FIG. 9 illustrates a method 300 for generating a trained model, such as a trained optimization model, in accordance with some embodiments. FIG. 10 is a process flow 350 illustrating various steps of the method 300 of generating a trained model, in accordance with some embodiments. At step 302, a training dataset 352 is received by a system, such as a processing device 10. The training dataset 352 can include labeled and/or unlabeled data. For example, in some embodiments, a set of labeled and/or semi-labeled data is provided for use in training a model. In some embodiments, the training dataset 352 includes historical network operation and/or status data. The historical network operation and/or status data can include data representative of previous network status, historical distribution, historical demand consumption, etc. within a target network.

At optional step 304, the received training dataset 352 is processed and/or normalized by a normalization module 360. For example, in some embodiments, the training dataset 352 can be augmented by imputing or estimating missing values of one or more features associated with a target network. In some embodiments, processing of the received training dataset 352 includes outlier detection configured to remove data likely to skew training of an optimization model. In some embodiments, processing of the received training dataset 352 includes removing features that have limited value with respect to training of a heuristic prediction model, a trained capacity prediction model, and/or a trained optimization model.

At step 306, an iterative training process is executed to train a selected model framework 362. The selected model framework 362 can include an untrained (e.g., base) machine learning model, such as a linear processing framework, and/or a partially or previously trained model (e.g., a prior version of a trained model). The training process is configured to iteratively adjust parameters (e.g., hyperparameters) of the selected model framework 362 to minimize a cost value (e.g., an output of a cost function) for the selected model framework 362. In some embodiments, the cost value is related to a fulfillment of network demand at demand nodes.

The training process is an iterative process that generates set of revised model parameters 366 during each iteration. The set of revised model parameters 366 can be generated by applying an optimization process 364 to the cost function of the selected model framework 362. The optimization process 364 can be configured to reduce the cost value (e.g., reduce the output of the cost function) at each step by adjusting one or more parameters during each iteration of the training process.

After each iteration of the training process, at step 308, a determination is made whether the training process is complete. The determination at step 308 can be based on any suitable parameters. For example, in some embodiments, a training process can complete after a predetermined number of iterations. As another example, in some embodiments, a training process can complete when it is determined that the cost function of the selected model framework 362 has reached a minimum, such as a local minimum and/or a global minimum.

At step 310, a trained model 368, such as a trained optimization model, is output and provided for use in a network optimization method, such as the hybrid optimization method 200 discussed above with respect to FIGS. 6-8. At optional step 312, a trained model 368 can be evaluated by an evaluation process 370. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a processor communicatively coupled to the non-transitory memory, wherein the processor is configured to read a set of instructions to:
receive a demand distribution optimization request for a target network;
generate a heuristic demand for one or more demand nodes in the target network;
generate a distribution channel capacity for a distribution channel connecting each of the one or more demand nodes and at least one distribution node;
generate an optimized fulfillment data structure representative of an optimized demand fulfillment for the one or more demand nodes by applying a mixed integer linear programming framework; and
store the optimized fulfillment data structure in a data storage mechanism.

2. The system of claim 1, wherein the heuristic demand comprises replenishment forecast for each of a plurality of consumable resources associated with the demand node.

3. The system of claim 1, wherein the optimized fulfillment data structure is generated by a trained optimization model including an item to demand node allocation cost, a distribution channel unit prioritization cost, and a less than minimum capacity cost.

4. The system of claim 3, wherein the demand node allocation cost comprises allocation of an i^{th} item at a j^{th} demand node at time t, a quantification factor for the i^{th} item at the j^{th} demand node at time t, and a weight vector.

5. The system of claim 3, wherein a weighting factor is applied to each of the item to demand node allocation cost, the distribution channel unit prioritization cost, and the less than minimum capacity cost.

6. The system of claim 1, wherein the optimized fulfillment data structure is generated by an iterative batched submodular process to assign distribution units of the distribution channel to each of the one or more demand nodes.

7. The system of claim 6, wherein the iterative batched submodular process assigns distribution units based on an incremental gain generated by assigning a distribution unit to one of the one or more demand nodes.

8. The system of claim 7, wherein an updated incremental gain is generated for a corresponding one of the one or more demand nodes when the distribution unit is assigned to the corresponding one of the one or more demand nodes.

9. A computer-implemented method, comprising:
receiving a demand distribution optimization request for a target network;
generating a heuristic demand for one or more demand nodes in the target network;
generating a distribution channel capacity for a distribution channel connecting each of the one or more demand nodes and at least one distribution node;
generating an optimized fulfillment data structure representative of an optimized demand fulfillment for the one or more demand nodes by applying a mixed integer linear programming framework; and
storing the optimized fulfillment data structure in a data storage mechanism.

10. The computer-implemented method of claim 9, wherein the heuristic demand comprises replenishment forecast for each of a plurality of consumable resources associated with the demand node.

11. The computer-implemented method of claim 9, wherein the optimized fulfillment data structure is generated by a trained optimization model including an item to demand node allocation cost, a distribution channel unit prioritization cost, and a less than minimum capacity cost.

12. The computer-implemented method of claim 11, wherein the demand node allocation cost comprises allocation of an i^{th} item at a j^{th} demand node at time t, a quantification factor for the i^{th} item at the j^{th} demand node at time t, and a weight vector.

13. The computer-implemented method of claim 11, wherein a weighting factor is applied to each of the item to demand node allocation cost, the distribution channel unit prioritization cost, and the less than minimum capacity cost.

14. The computer-implemented method of claim 9, wherein the optimized fulfillment data structure is generated by an iterative batched submodular process to assign distribution units of the distribution channel to each of the one or more demand nodes.

15. The computer-implemented method of claim 14, wherein the iterative batched submodular process assigns distribution units based on an incremental gain generated by assigning a distribution unit to one of the one or more demand nodes.

16. The computer-implemented method of claim 15, wherein an updated incremental gain is generated for a corresponding one of the one or more demand nodes when the distribution unit is assigned to the corresponding one of the one or more demand nodes.

17. A non-transitory computer-readable medium having instructions stored thereon, wherein the instructions, when executed by at least one processor, cause at least one device to perform operations comprising:
receiving a demand distribution optimization request for a target network;
generating a heuristic demand for one or more demand nodes in the target network;
generating a distribution channel capacity for a distribution channel connecting each of the one or more demand nodes and at least one distribution node;
generating an optimized fulfillment data structure representative of an optimized demand fulfillment for the one or more demand nodes by applying a mixed integer linear programming framework incorporating an item to demand node allocation cost, a distribution channel unit prioritization cost, and a less than minimum capacity cost; and
storing the optimized fulfillment data structure in a data storage mechanism.

18. The non-transitory computer-readable medium of claim 17, wherein the demand node allocation cost comprises allocation of an i^{th} item at a j^{th} demand node at time t, a quantification factor for the i^{th} item at the j^{th} demand node at time t, and a weight vector.

19. The non-transitory computer-readable medium of claim 17, wherein the optimized fulfillment data structure is generated by a trained optimization model configured to apply a iterative batched submodular process to assign distribution units of the distribution channel to each of the one or more demand nodes.

20. The non-transitory computer-readable medium of claim 19, wherein the iterative batched submodular process assigns distribution units based on an incremental gain generated by assigning a distribution unit to one of the one or more demand nodes, and wherein an updated incremental gain is generated for a corresponding one of the one or more demand nodes when the distribution unit is assigned to the corresponding one of the one or more demand nodes.
